(19) United States
(12) Patent Application Publication
(10) Pub. No.: US 2018/0082339 A1
(43) Pub. Date: Mar. 22, 2018

(54) COGNITIVE ADVERTISEMENT OPTIMIZATION

(71) Applicant: INTERNATIONAL BUSINESS MACHINES CORPORATION, Armonk, NY (US)

(72) Inventors: Norbert Herman, Denver, CO (US); Sarbajit K. Rakshit, Kolkata (IN); Craig M. Trim, Sylmar, CA (US); Henry C. Will, IV, Dover, NJ (US)

(21) Appl. No.: 15/656,136

(22) Filed: Jul. 21, 2017

Related U.S. Application Data
(63) Continuation of application No. 15/272,556, filed on Sep. 22, 2016.

(51) Int. Cl. G06Q 30/02

(52) U.S. Cl. CPC G06Q 30/0276; G06Q 30/0269

(57) ABSTRACT

A method for generating and presenting customized advertisement messages to consumers is provided. The method may include receiving advertisement messages. The method may further include identifying first essential portions and first non-essential portion in each received advertisement message. Additionally, the method may include presenting the received advertisement messages to consumers based on the first essential portions and the first non-essential portions. The method may also include collecting consumer profile data on each consumer based on the presented received advertisement messages. The method may further include identifying second essential portions and second non-essential portions in each of the presented received advertisement messages. The method may also include customizing the presented received advertisement messages based on the first essential portions, the first non-essential portions, the second essential portions, and the second non-essential portions. The method may further include presenting the customized advertisement messages based on each consumer.

### BACKGROUND

The present invention relates generally to the field of computing, and more specifically, to data analysis associated with advertisements.

Generally, advertisements are marketing communications used to promote businesses and/or products. Furthermore, advertisement messages are typically viewed on media such as newspapers, magazines, radio and television, and may be aimed at particular demographics. For example, television commercials may be broadcasted on television advertising slots and used to generate increased consumption of products or services through branding, whereby a product name or image may be associated with certain qualities to entice consumers. Additionally, statistical data associated with the consumers of advertisements may be used to determine what types of consumers are consuming the advertisements. Typically, the statistical data includes the age and gender of consumers. Furthermore, the collecting of statistical data may entail such methodologies as pre-testing and post-testing of advertisements and/or campaigns.

### SUMMARY

A method for generating and presenting a plurality of customized advertisement messages to a plurality of consumers is provided. The method may include receiving a plurality of advertisement messages. The method may further include identifying at least one first essential portion and at least one first non-essential portion in each received advertisement message associated with the received plurality of advertisement messages. Additionally, the method may include presenting the received plurality of advertisement messages to a plurality of consumers based on the identified at least one first essential portion and the identified at least one first non-essential portion. The method may also include collecting a plurality of consumer profile data on each consumer associated with the plurality of consumers based on the presented received plurality of advertisement messages. The method may further include, based on the collected plurality of consumer profile data, identifying at least one second essential portion and at least one second non-essential portion in each of the presented advertisement messages associated with the presented received plurality of advertisement messages. The method may also include customizing the presented plurality of advertisement messages based on the identified at least one first essential portion, the identified at least one first non-essential portion, the identified at least one second essential portion, and the identified at least one second non-essential portion, to generate the plurality of customized advertisement messages for each consumer associated with the plurality of consumers. The method may further include presenting the plurality of customized advertisement messages based on each consumer associated with the plurality of consumers.

A computer system for generating and presenting a plurality of customized advertisement messages to a plurality of consumers is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a plurality of advertisement messages. The method may further include identifying at least one first essential portion and at least one first non-essential portion in each received advertisement message associated with the received plurality of advertisement messages. Additionally, the method may include presenting the received plurality of advertisement messages to a plurality of consumers based on the identified at least one first essential portion and the identified at least one first non-essential portion. The method may also include collecting a plurality of consumer profile data on each consumer associated with the plurality of consumers based on the presented received plurality of advertisement messages. The method may further include, based on the collected plurality of consumer profile data, identifying at least one second essential portion and at least one second non-essential portion in each of the presented received advertisement messages associated with the presented plurality of advertisement messages. The method may also include customizing the presented plurality of advertisement messages based on the identified at least one first essential portion, the identified at least one first non-essential portion, the identified at least one second essential portion, and the identified at least one second non-essential portion, to generate the plurality of customized advertisement messages for each consumer associated with the plurality of consumers. The method may further include presenting the plurality of customized advertisement messages based on each consumer associated with the plurality of consumers.

A computer program product for generating and presenting a plurality of customized advertisement messages to a plurality of consumers is provided. The computer program product may include one or more computer-readable storage devices and program instructions stored on at least one of the one or more tangible storage devices, the program instructions executable by a processor. The computer program product may include program instructions to receive a plurality of advertisement messages. The computer program product may further include program instructions to identify at least one first essential portion and at least one first non-essential portion in each received advertisement message associated with the received plurality of advertisement messages. Additionally, the computer program product may also include program instructions to present the received plurality of advertisement messages to a plurality of consumers based on the identified at least one first essential portion and the identified at least one first non-essential portion. The computer program product may further include program instructions to collect a plurality of consumer profile data on each consumer associated with the plurality of consumers based on the presented received plurality of advertisement messages. The computer program product may also include program instructions to, based on the collected plurality of consumer profile data, identify at least one second essential portion and at least one second non-essential portion in each of the presented received advertisement messages associated with the presented plurality of advertisement messages. The computer program product may further include program instructions to customize the presented plurality of advertisement messages based on the identified at least one first essential portion, the identified at least one first non-essential portion, the identified at least one second essential portion, and the identified at least one second non-essential portion, to generate the plurality of customized advertisement messages for each consumer associated with the plurality of consumers. The computer program product may also include program instructions to present the plurality of customized advertisement messages based on each consumer associated with the plurality of consumers.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2A is an example of a program for presenting advertisement messages on an advertising display slot according to one embodiment;

FIG. 2B is an example of received advertisement messages that may be customized and presented on advertising display slots according to one embodiment;

FIG. 3 is an operational flowchart illustrating the steps carried out by a program for generating and presenting customized advertisement messages to consumers according to one embodiment;

FIG. 4 is a block diagram of the system architecture of a program for generating and presenting customized advertisement messages to consumers according to one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to data analysis associated with advertisements. The following described exemplary embodiments provide a system, method and program product for generating and presenting customized advertisement messages to users. Therefore, the present embodiment has the capacity to improve the technical field associated with advertising by providing users essential and/or nonessential portions of advertisements by customizing advertisements for each user and presenting the customized advertisements in allotted advertising slots. Specifically, the present embodiment may receive advertisement messages, identify essential portions and non-essential portions of the advertisement messages based on contextual analysis and consumer statistics, and present customized versions of the advertisement messages based on the contextual analysis and the consumer statistics.

As previously described with respect to data analysis associated with advertisements, advertisements such as television commercials may be used to generate increased consumption of products and services. For example, statistical data may be used to determine what types of consumers are consuming the advertisements. As previously described, the statistical data typically includes the age and gender of consumers, and collecting statistical data may typically entail pre-testing and post-testing advertisements and/or campaigns. However, such methodologies follow the traditional linear entertainment model of advertising, whereby advertisements are presented in the same way to large but disparate audiences without regard for consumer preferences. Furthermore, portions of advertisements that are determined to be interesting to users may be cut out due to shortened allotted times associated with advertising slots. As such, it may be advantageous, among other things, to provide a system, method and program product for generating and presenting customized advertisement messages to users. Specifically, the system, method, and program product may receive advertisement messages, identify essential portions and non-essential portions of the advertisement messages based on contextual analysis and consumer statistics, and present customized versions of the advertisement messages based on the contextual analysis and the consumer statistics.

According to at least one implementation of the present embodiment, advertisement messages may be received. Next, first essential portions and first non-essential portions of the received advertisement messages may be identified. Then, based on the identified first essential portions, the identified first non-essential portions, and a time associated with an advertisement time slot, the received advertisement messages may be presented to consumers. Next, based on the presented received advertisement messages, consumer profile data associated with a plurality of consumers may be collected. Then, based on the collected consumer profile data, second essential portions and second non-essential portions associated with the presented received advertisement messages may be identified. Next, customized advertisement messages may be generated by customizing the presented received advertisement messages based on the identified first essential portions, the identified first non-essential portions, the identified second essential portions and the second non-essential portions of the received advertisement messages. Next, the customized advertisement messages may be presented according to each consumer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for generating and presenting customized advertisement messages to consumers.

According to at least one implementation, advertisement messages may be received. Next, first essential portions and first non-essential portions of the received advertisement messages may be identified. Then, based on the identified first essential portions, the identified first non-essential portions, and a time associated with an advertisement time slot, the received advertisement messages may be presented to consumers. Next, based on the presented received advertisement messages, consumer profile data associated with a plurality of consumers may be collected. Then, based on the collected consumer profile data, second essential portions and second non-essential portions associated with the presented received advertisement messages may be identified. Next, customized advertisement messages may be generated by customizing the presented received advertisement messages based on the identified first essential portions, the identified first non-essential portions, the identified second essential portions and the second non-essential portions of the received advertisement messages. Next, the customized advertisement messages may be presented according to each consumer.

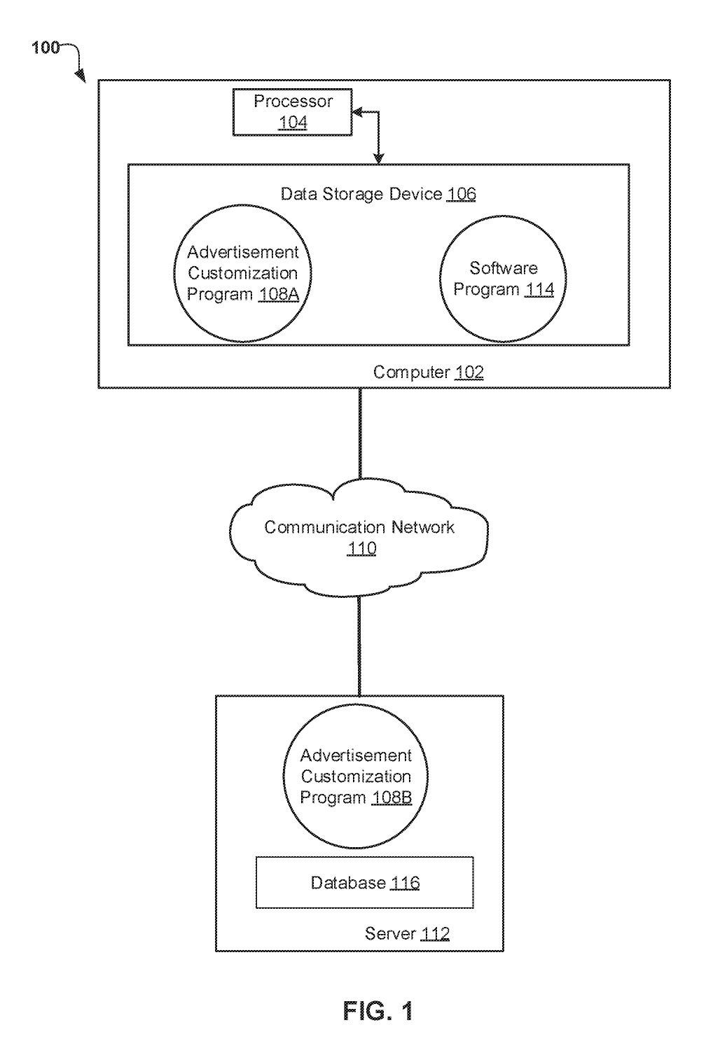

Referring now to FIG. 1, an exemplary networked computer environment 100 in accordance with one embodiment is depicted. The networked computer environment 100 may include a computer 102 with a processor 104 and a data storage device 106 that is enabled to run an advertisement customization program 108A and a software program 114. The software program 114 may be an application program such as a television program, a web program, and an email program. The advertisement customization program 108A may communicate with the software program 114. The networked computer environment 100 may also include a server 112 that is enabled to run an advertisement customization program 108B and a communication network 110. The networked computer environment 100 may include a plurality of computers 102 and servers 112, only one of which is shown for illustrative brevity.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

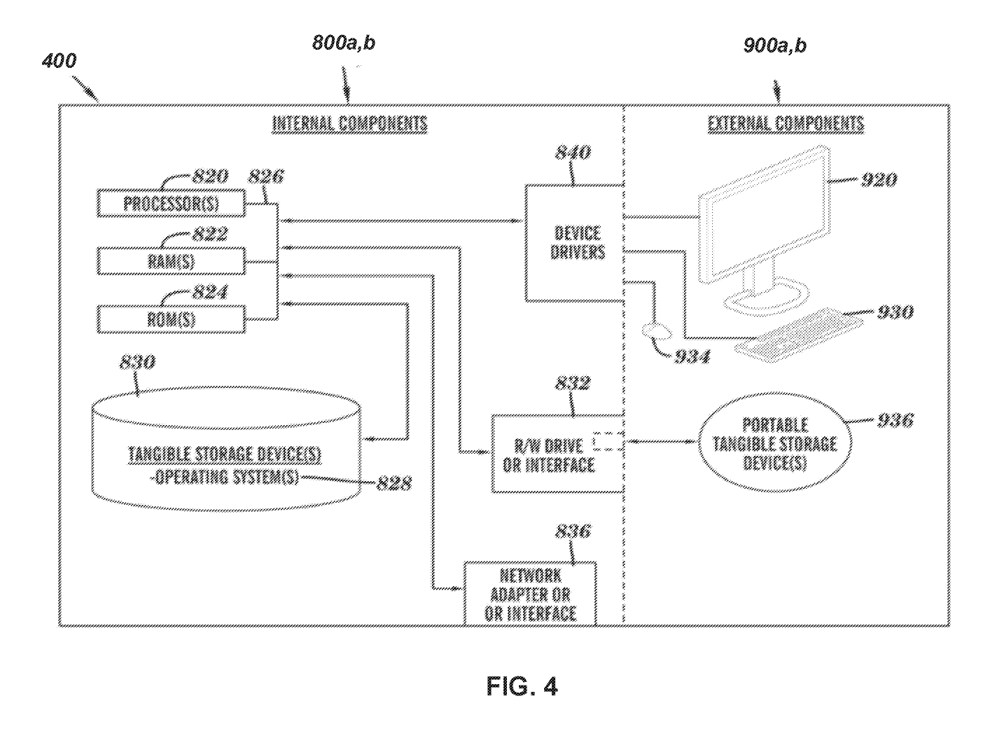

The client computer 102 may communicate with server computer 112 via the communications network 110. The communications network 110 may include connections, such as wire, wireless communication links, or fiber optic cables. As will be discussed with reference to FIG. 4, server computer 112 may include internal components 800a and external components 900a, respectively, and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a set top box, a television device, a telephone, a personal digital assistant, a netbook, a laptop computer, a tablet computer, a desktop computer, or any type of computing device and dynamic digital advertisement display capable of running a program and accessing a network. According to various implementations of the present embodiment, the advertisement customization program 108A, 108B may interact with a database 116 that may be embedded in various storage devices, such as, but not limited to a mobile device 102, a networked server 112, or a cloud storage service.

According to the present embodiment, a program, such as an advertisement customization program 108A and 108B may run on the client computer 102 or on the server computer 112 via a communications network 110. The advertisement customization program 108A, 108B may generate and present customized advertisement messages to users. Specifically, a user using a computer, such as computer 102, may run an advertisement customization program 108A, 108B, that interacts with a software program 114, to receive advertisement messages, identify essential portions and non-essential portions of the advertisement messages based on contextual analysis and consumer statistics, and present customized versions of the advertisement messages for each consumer based on the contextual analysis and the consumer profile data.

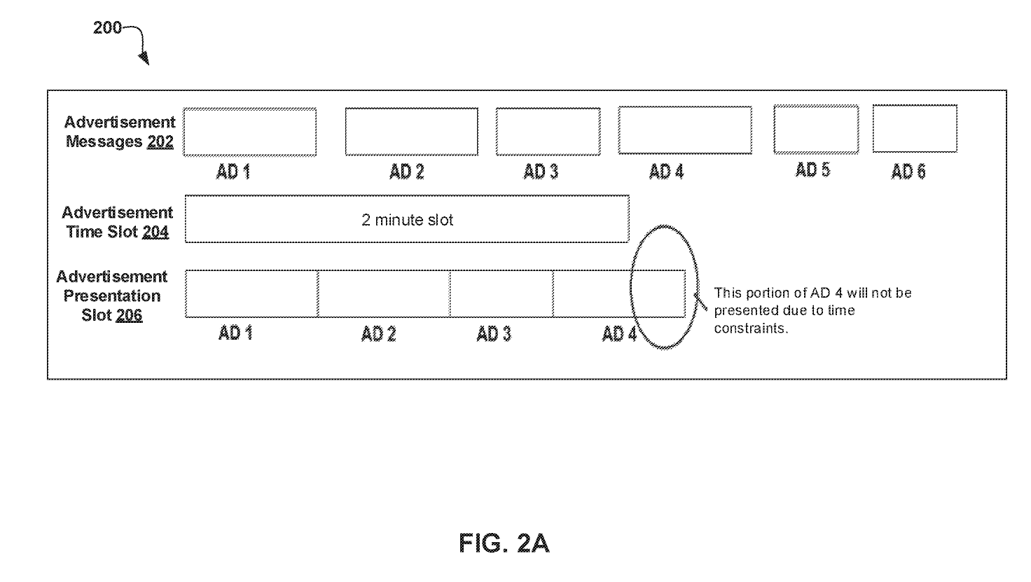

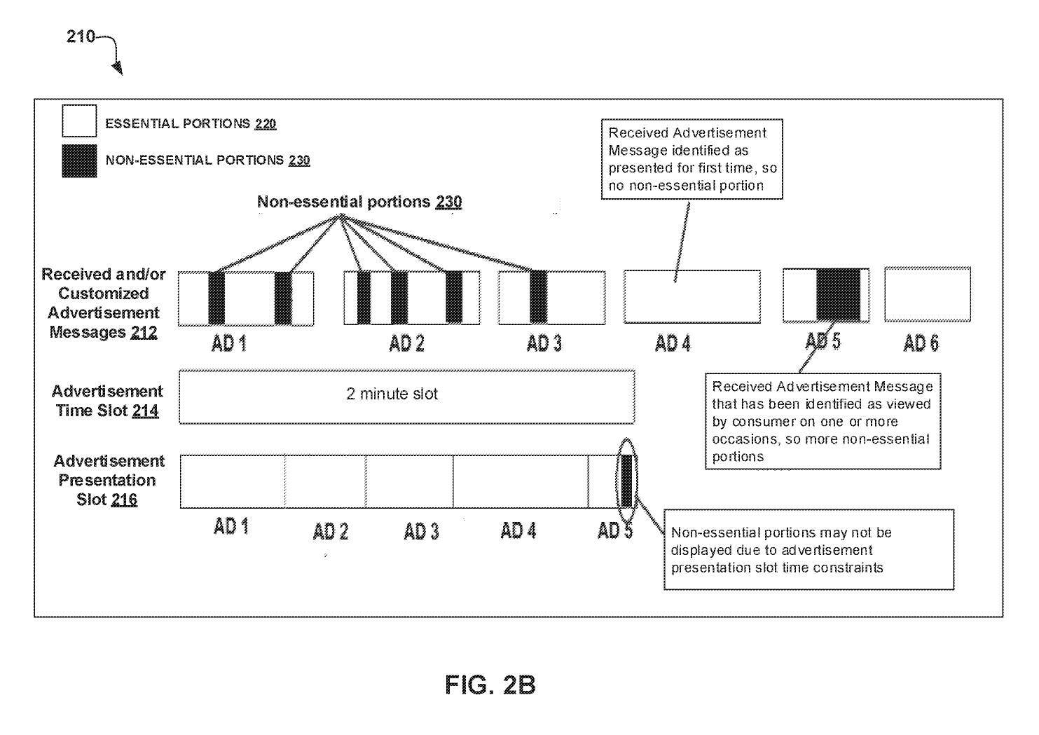

Referring now to FIG. 2A, an example 200 of a program 114 (FIG. 1) for presenting advertisement messages 202 on an advertising display slot 206 is depicted. Specifically, and as previously described, portions of advertisement messages 202 that may be associated with a program 114 (FIG. 1), such as a television program and a web program, and that are interesting to consumers and/or important for the advertisement messages 202, are cut off/short due to time constraints associated with advertising time slots 204. For example, advertisement messages 202 may include advertisements AD 1, AD 2, AD 3, AD 4, AD 5, and AD 6. Furthermore, based on the program 114 (FIG. 1), a time, such as 2 minutes, may be allotted to an advertising time slot 204 to broadcast the advertisement messages 202 on a device, such as a television device or a set top box. However, the advertisement messages 202 may have an entire combined runtime of over 2 mins. Therefore, the program 114 (FIG. 1) may not only present the entirety of the advertisement messages 202 without regard to consumer preferences, but the program 114 (FIG. 1) also does not account for cutting off an important and/or interesting portion of an advertisement message 202 due to the time constraints associated with the advertising time slot 204 as depicted by the cutting off of AD 4 of the advertisement message 202 on the advertising presentation slot 206.

Referring now to FIG. 2B, an example 210 of received advertisement messages 212 that may be customized and presented on advertising display slots 216 according to one embodiment of the present invention is depicted. As previously described in FIG. 2A, programs 114 (FIG. 1) may present advertisement messages 202 (FIG. 2A) without regard to consumer preferences, and may not account for cutting off important and/or interesting portions of advertisement messages 202 (FIG. 2A) due to time constraints. As such, the advertisement customization program 108A, 108B (FIG. 1) may receive the advertisement messages 212 and may identify essential portions 220 and non-essential portions 230 associated with received advertisement messages 212. Specifically, the advertisement customization program 108A, 108B (FIG. 1) may identify essential portions 220 and non-essential portions 230 associated with received advertisement messages 212 by analyzing the received advertisement messages 212 and consumer profile data associated with the received advertisement messages 212. More specifically, the advertisement customization program 108A, 108B (FIG. 1) may present the received advertisement messages 212 to consumers and collect consumer profile data on the consumers. Then, based on the analysis and the consumer profile data, the advertisement customization program 108A, 108B (FIG. 1) may generate customized versions of the received advertisement messages 212 for each consumer and identify the essential portions 220 and the non-essential portions 230 of the customized versions of the received advertisement messages 212 for each consumer.

Therefore, the advertisement customization program 108A, 108B (FIG. 1) may present the customized versions of the advertisement messages 212 whereby non-essential portions may or may not be removed based on the analysis, consumer profile data, and time constraints, as depicted by AD 5 of the customized version of advertisement messages 212 on the advertisement presentation slot 216. Furthermore, according to one embodiment, the advertisement customization program 108A, 108B (FIG. 1) may identify received advertisement messages 212 that may be presented to consumers for the first time, and therefore, may not include non-essential portions 230, as depicted by AD 4 and AD 6 of the received advertisement message 212.

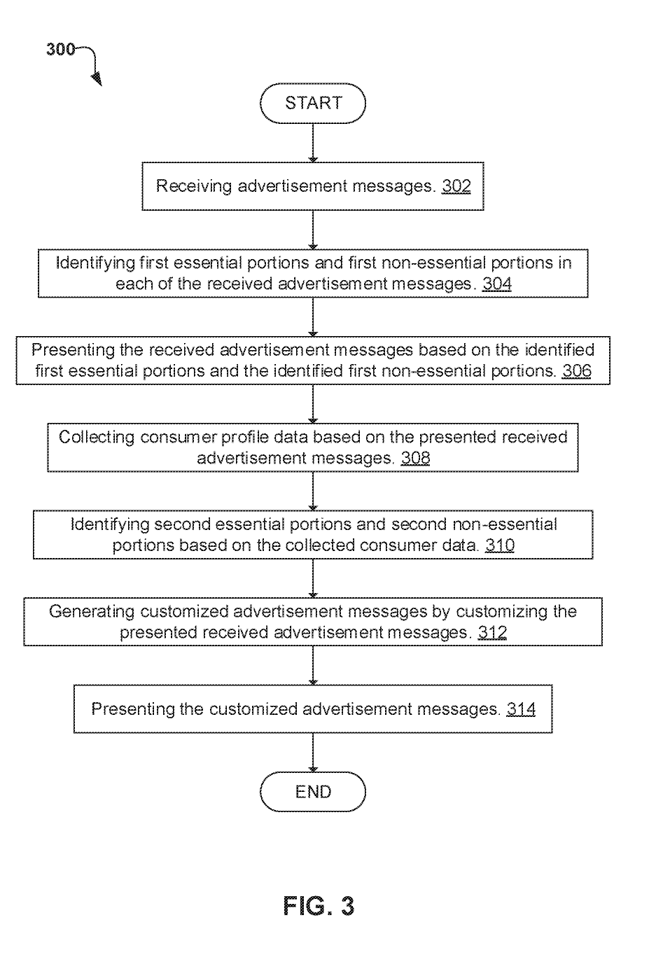

Referring now to FIG. 3, an operational flowchart 300 illustrating the steps carried out by a program for generating and presenting customized advertisement messages is depicted. At 302, the advertisement customization program 108A, 108B (FIG. 1) may receive advertisement messages 212 (FIG. 2B). For example, the advertisement customization program 108A, 108B (FIG. 1) may receive advertisement messages 212 (FIG. 2B) such as television commercials, radio advertisements, and application advertisements that include video advertisements and picture advertisements associated with a software program 114 (FIG. 1) such as an application.

Then, at 304, the advertisement customization program 108A, 108B (FIG. 1) may identify first essential portions 220 (FIG. 2B) and first non-essential portions 230 (FIG. 2B) associated with the received advertisement messages 212 (FIG. 2B). Specifically, according to one embodiment, the advertisement customization program 108A, 108B (FIG. 1) may enable users/advertisers to define portions of the received advertisement messages 212 (FIG. 2B) that are first essential portions 220 (FIG. 2B) and that are first non-essential portions 230 (FIG. 2B), whereby the first essential portions 220 (FIG. 2B) are portions that may be required to be presented and/or that are essential to consumers, and the first non-essential portions 230 (FIG. 2B) are portions that may not be required to be presented and/or that are non-essential to consumers.

For example, the advertisement customization program 108A, 108B (FIG. 1) may receive an advertisement message 212 (FIG. 2B) such as a television car commercial that includes video clips such as a clip of a celebrity driving a car, a clip of the car on a rotating platform, a clip of the interior of the car, a clip of the celebrity in a restaurant, a clip of the celebrity standing next to the car, and a clip of a price deal associated with the car that is offered for a month. Thereafter, the advertisement customization program 108A, 108B (FIG. 1) may enable users/advertisers to define the clip of the interior of the car, the clip of the celebrity standing next to the car, and the clip of the price deal associated with the car as first essential portions 220 (FIG. 2B), and enable users/advertisers to define the clip of the celebrity driving the car, the clip of the car on a rotating platform, and the clip of the celebrity in the restaurant as first non-essential portions 230 (FIG. 2B).

Then, the advertisement customization program 108A, 108B (FIG. 1) may identify the first essential portions 220 (FIG. 2B) and the first non-essential portions 230 (FIG. 2B) associated with the received advertisement messages 212 (FIG. 2B), by analyzing the definitions created by the users/advertisers. Furthermore, and as previously described in FIG. 2B, the advertisement customization program 108A, 108B (FIG. 1) may identify the received advertisement messages 212 (FIG. 2B) that may be presented to consumers for the first time, and therefore, may not include the first non-essential portions 230 (FIG. 2B), as depicted by AD 4 and AD 6 of the received advertisement messages 212 (FIG. 2B).

Next, at 306, the advertisement customization program 108A, 108B (FIG. 1) may present the received advertisement messages 212 (FIG. 2B) to consumers based on the identified first essential portions 220 (FIG. 2B) and the identified first non-essential portions 230 (FIG. 2B). As previously described at step 304, the advertisement customization program 108A, 108B (FIG. 1) may identify first essential portions 220 (FIG. 2B) and first non-essential portions 230 (FIG. 2B) associated with the received advertisement messages 212 (FIG. 2B). Thereafter, the advertisement customization program 108A, 108B (FIG. 1) may present the received advertisement messages 212 (FIG. 2B) to consumers. Specifically, and as previously described in FIG. 2B, the advertisement customization program 108A, 108B (FIG. 1) may determine a time associated with an advertisement time slot 214 (FIG. 2B) and present the received advertisement messages 212 (FIG. 2B) to consumers based on the time, the identified first essential portions 220 (FIG. 2B), and the identified first non-essential portions 230 (FIG. 2B).

For example, the advertisement customization program 108A, 108B (FIG. 1) may receive advertisement messages 212 (FIG. 2B) that may include television commercial advertisements, such as AD 1, AD 2, AD 3, AD 4, AD 5, and AD 6, that have a combined runtime of 5 minutes. Furthermore, based on a television program 114 (FIG. 1), a time such as 2 minutes may be allotted to the advertising time slot 214 (FIG. 2B) associated with the television program 114 (FIG. 1) for presenting the received advertisement messages 212 (FIG. 2B). As such, based on the 2 minute advertisement time slot, the advertisement customization program 108A, 108B (FIG. 1) may present the identified first essential portions 220 (FIG. 2B) without presenting the identified first non-essential portions 230 (FIG. 2B) to improve getting the advertiser's message across to consumers within the allotted 2 minute time slot. Furthermore, according to one embodiment, in response to determining that the advertising time slot 214 (FIG. 2B) includes enough time to present the identified first essential portions 220 (FIG. 2B) and the identified first non-essential portions 230 (FIG. 2B), the advertisement customization program 108A, 108B (FIG. 1) may present the received advertisement messages 212 (FIG. 2B) with both the identified first essential portions 220 (FIG. 2B) and the identified first non-essential portions 230 (FIG. 2B).

Then, at 308, the advertisement customization program 108A, 108B (FIG. 1) may collect consumer profile data associated with a plurality of consumers based on the presented received advertisement messages 212 (FIG. 2B). As previously described at step 306, the advertisement customization program 108A, 108B (FIG. 1) may present the received advertisement messages 212 (FIG. 2B) to consumers based on the identified first essential portions 220 (FIG. 2B), the identified first non-essential portions 230 (FIG. 2B), and a time associated with the advertisement time slot 214 (FIG. 2B). Therefore, the advertisement customization program 108A, 108B (FIG. 1) may collect consumer profile data based on consumers consuming the information associated with the identified first essential portions 220 (FIG. 2B) and the identified first non-essential portions 230 (FIG. 2B).

For example, the advertisement customization program 108A, 108B (FIG. 1) may collect consumer profile data on a database, such as the database 116 (FIG. 1), by using a camera associated with a computing device, such as the computer 102 (FIG. 1), to determine for example whether consumers are viewing the identified first essential portions 220 (FIG. 2B) and the identified first non-essential portions 230 (FIG. 2B) associated with the presented received advertisement message 212 (FIG. 2B). Specifically, the advertisement customization program 108A, 108B (FIG. 1) may use the camera to determine whether consumers turn to a different channel on a television program when an identified first essential portion 220 (FIG. 2B) and/or an identified first non-essential portion 230 (FIG. 2B) associated with a commercial is presented, and/or use the camera to detect consumers' facial expressions and determine whether the consumers register boredom or excitement. Furthermore, for example, the advertisement customization program 108A, 108B (FIG. 1) may determine whether consumers skip a video segment on an application when an advertisement video is presented. Additionally, for example, the advertisement customization program 108A, 108B (FIG. 1) may to determine whether consumers turn to a different channel on a radio program when an identified first essential portion 220 (FIG. 2B) and/or an identified first non-essential portion 230 (FIG. 2B) associated with a radio advertisement is presented. Also, for example, the advertisement customization program 108A, 108B (FIG. 1) may collect consumer profile data by detecting whether a consumer/viewer puts their phone down when a received advertisement message 212 (FIG. 2B) is presented, detecting whether the consumer/viewer is opening other applications when a received advertisement message 212 (FIG. 2B) is presented, and/or detecting, through a wearable device, whether a consumer/viewer leaves a room when the received advertisement message 212 (FIG. 2B) is presented.

Next, at 310, based on the collected consumer profile data, the advertisement customization program 108A, 108B (FIG. 1) may identify second essential portions 220 (FIG. 2B) and second non-essential portions 230 (FIG. 2B) of the received advertisement messages 212 (FIG. 2B). As previously described at step 304, the advertisement customization program 108A, 108B (FIG. 1) may identify first essential portions 220 (FIG. 2B) and first non-essential portions 230 (FIG. 2B) associated with the received advertisement messages 212 (FIG. 2B). Furthermore, and as previously described at steps 306 and 308, the advertisement customization program 108A, 108B (FIG. 1) may present the received advertisement messages 212 (FIG. 2B) to consumers and collect consumer profile data associated with a plurality of consumers based on the presented received advertisement messages. Thereafter, the advertisement customization program 108A, 108B (FIG. 1) may identify second essential portions 220 (FIG. 2B) and second non-essential portions 230 (FIG. 2B) that may or may not modify the first essential portions 220 (FIG. 2B) and the first non-essential portions 230 (FIG. 2B) associated with the presented received advertisement messages 212 (FIG. 2B) based on the collected consumer profile data.

For example, and as previously described, the advertisement customization program 108A, 108B (FIG. 1) may enable users/advertisers to define portions of a television car commercial such as defining the clip of the interior of the car, the clip of the celebrity standing next to the car, and the clip of the price deal associated with the car as first essential portions 220 (FIG. 2B), and defining the clip of the celebrity driving the car, the clip of the car on a rotating platform, and the clip of the celebrity in the restaurant as first non-essential portions 230 (FIG. 2B). However, based on the collected consumer profile data associated with a consumer that is presented with the television car commercial, the advertisement customization program 108A, 108B (FIG. 1) may determine that the clip of the celebrity standing next to the car is a non-essential portion 230 (FIG. 2B) to that consumer. Therefore, the advertisement customization program 108A, 108B (FIG. 1) may identify the clip of the celebrity standing next to the car as a second non-essential portion 230 (FIG. 2B), and may modify the television car commercial advertisement accordingly. Furthermore, for example, the advertisement customization program 108A, 108B (FIG. 1) may determine that the clip of the car on a rotating platform is an essential portion 220 (FIG. 2B) to that consumer. Therefore, the advertisement customization program 108A, 108B (FIG. 1) may identify the clip of the car as a second essential portion 220 (FIG. 2B), and may modify the television car commercial advertisement accordingly. Additionally, the advertisement customization program 108A, 108B (FIG. 1) may determine that certain identified first essential portions 220 (FIG. 2B) are the same as the identified second essential portions 220 (FIG. 2B), and that certain identified first non-essential portions 230 (FIG. 2B) are the same as the identified second non-essential portions 230 (FIG. 2B), based on the user/advertiser definitions and the collected consumer profile data.

Then, at 312 the advertisement customization program 108A, 108B (FIG. 1) may generate customized advertisement messages 212 (FIG. 2B) by customizing the presented received advertisement messages 212 (FIG. 2B) for each consumer. Specifically, the advertisement customization program 108A, 108B (FIG. 1) may customize the presented received advertisement messages 212 (FIG. 2B) for each consumer based on the identified first essential portions 220 (FIG. 2B), the identified first non-essential portions 230 (FIG. 2B), the identified second essential portions 220 (FIG. 2B), and the identified second non-essential portions 230 (FIG. 2B) associated with the presented received advertisement messages 212 (FIG. 2B) that are identified based on the user/advertiser definitions and the collected consumer profile data for each consumer. For example, based on the consumer and the television car commercial as previously described at step 310, the advertisement customization program 108A, 108B (FIG. 1) may customize the television car commercial such that only the identified first essential portions 220 (FIG. 2B) and the identified second essential portions 220 (FIG. 2B) may be presented to that consumer. Furthermore, for a different consumer, the advertisement customization program 108A, 108B (FIG. 1) may customize the television car commercial such that a different set of clips identified as first essential portions 220 (FIG. 2B) and second essential portions 220 (FIG. 2B) may be presented to that different consumer according to user/advertiser definitions and collected consumer profile data associated with the different consumer.

Next, at 314, the advertisement customization program 108A, 108B (FIG. 1) may present the customized advertisement messages based on each consumer as well as the identified first essential portions 220 (FIG. 2B), the identified first non-essential portions 230 (FIG. 2B), the identified second essential portions 220 (FIG. 2B), and the identified second non-essential portions 230 (FIG. 2B) associated with the presented received advertisement messages 212 (FIG. 2B) that are identified based on the user/advertiser definitions and the collected consumer profile data for each consumer. For example, for consumer A, the advertisement customization program 108A, 108B (FIG. 1) may present only the clip of the car on a rotating platform and the clip of the price deal associated with the car, while for consumer B the advertisement customization program 108A, 108B (FIG. 1) may present only the clip of the celebrity standing next to the car and the clip of the price deal associated with the car.

It may be appreciated that FIGS. 2A, 2B, and 3 provide only illustrations of one implementation and do not imply any limitations with regard to how different embodiments may be implemented. Many modifications to the depicted environments may be made based on design and implementation requirements. For example, at step 304 in FIG. 3, the advertisement customization program 108A, 108B (FIG. 1) may identify the first essential portions 220 (FIG. 2B) and the first non-essential portions 230 (FIG. 2B) at step 304 based on not only the user/advertiser definitions but on collected consumer profile data as well. Specifically, the advertisement messages 212 (FIG. 2B) that are received by the advertisement customization program 108A, 108B (FIG. 1) may include customized advertisement messages 212 (FIG. 2B) that have been presented to consumers on one or more occasions.

Therefore, the advertisement customization program 108A, 108B (FIG. 1) may identify the first essential portions 220 (FIG. 2B) and the first non-essential portions 230 (FIG. 2B) associated with the customized advertisement messages 212 (FIG. 2B) based on the user/advertiser definitions as well as the consumer profile data that is collected each time the consumer consumes the customized advertisement message 212 (FIG. 2B). For example, in FIG. 2B, AD 5 may be a customized advertisement message 212 (FIG. 2B) that is consumed by a consumer on one or more occasions, and therefore, AD 5 may include more first non-essential portions 230 (FIG. 2B) than first essential portions 220 (FIG. 2B) based on the consumer's familiarity with AD 5. Thereafter, the advertisement customization program 108A, 108B (FIG. 1) may additionally identify second essential portions 220 (FIG. 2B) and second non-essential portions 230 (FIG. 2B) at step 310 that may additionally modify the identified first essential portions 220 (FIG. 2B) and the identified first non-essential portions 230 (FIG. 2B), whereby more non-essential portions may be identified based on the consumer's familiarity.

Furthermore, according to one embodiment, the advertisement customization program 108A, 108B (FIG. 1) may also include prioritizing portions of the received/customized advertisements messages 212 (FIG. 2B). Specifically, the advertisement customization program 108A, 108B (FIG. 1) may prioritize portions of the received/customized advertisement messages 212 (FIG. 2B) by ranking portions of the received advertisement messages, and/or by ranking the identified essential portions 220 (FIG. 2B) and the identified non-essential portions 230 (FIG. 2B) associated with the received/customized advertisement messages 212 (FIG. 2B), based on the consumer profile data that is collected each time the consumer consumes the received/customized advertisement messages 212 (FIG. 2B). Thereafter, the advertisement customization program 108A, 108B (FIG. 1) may prioritize, or rank the importance of each of the identified first essential portions 220 (FIG. 2B), the identified first non-essential portions 230 (FIG. 2B), the identified second essential portions 220 (FIG. 2B), and the identified second non-essential portions 230 (FIG. 2B).

For example, and as previously described at step 304 in FIG. 3, the advertisement customization program 108A, 108B (FIG. 1) may receive an advertisement message 212 (FIG. 2B), such as a television car commercial, that includes video clips such as a clip of a celebrity driving a car, a clip of the car on a rotating platform, a clip of the interior of the car, a clip of the celebrity in a restaurant, a clip of the celebrity standing next to the car, and a clip of a price deal associated with the car that is offered for a month. Therefore, according to one embodiment, based on the consumer profile data that is collected each time the consumer consumes the television car commercial, the advertisement customization program 108A, 108B (FIG. 1) may prioritize/rank the importance of each video clip, for example, by ranking each video clip based on a scale of 1 to 10, and generating and presenting customized advertisement messages 212 (FIG. 2B) for each consumer based on the prioritization/ranking, wherein the ranking determines a priority level of each video clip for each consumer and the video clips are presented based on ranking order. Also, according to one embodiment, the advertisement customization program 108A, 108B (FIG. 1) may identify the first essential portions 220 (FIG. 2B), the first non-essential portions 230 (FIG. 2B), the second essential portions 220 (FIG. 2B), and the second non-essential portions 230 (FIG. 2B) associated with the television car commercial. Then, the advertisement customization program 108A, 108B (FIG. 1) may prioritize/rank the importance of each of the identified first essential portions 220 (FIG. 2B), the identified first non-essential portions 230 (FIG. 2B), the identified second essential portions 220 (FIG. 2B), and the identified second non-essential portions 230 (FIG. 2B), and thereafter generate and present customized advertisement messages 212 (FIG. 2B) based on the prioritization/ranking.

Also, according to one embodiment, and as previously described with respect to prioritizing portions of the received/customized advertisements messages 212 (FIG. 2B), the advertisement customization program 108A, 108B (FIG. 1) may enable advertisers to define the priority for each portion of the received/customized advertisement messages 212 (FIG. 2B). Specifically, and as previously described, the advertisement customization program 108A, 108B (FIG. 1) may enable advertisers to define the priority for portions of the received advertisement messages by ranking portions of the received advertisement messages, and/or by ranking the identified essential portions 220 (FIG. 2B) and the identified non-essential portions 230 (FIG. 2B) associated with the received/customized advertisement messages 212 (FIG. 2B).

For example, and as previously described at step 304 in FIG. 3, the advertisement customization program 108A, 108B (FIG. 1) may receive an advertisement message 212 (FIG. 2B), such as a television car commercial, that includes video clips such as a clip of a celebrity driving a car, a clip of the interior of the car, a clip of the celebrity standing next to the car, and a clip of a price deal associated with the car. As such, the advertisement customization program 108A, 108B (FIG. 1) may enable advertisers to prioritize the video clips by, for example, ranking or placing higher priorities on the clip of the interior of the car and the clip of the price deal associated with the car over the clips involving the celebrity, which may be given a lower priority due the celebrity being paid based on a number of views of the received/customized advertisements messages 212 (FIG. 2B) that may result in high expenses.

Additionally, the advertisement customization program 108A, 108B (FIG. 1) may filter the identified essential portions 220 (FIG. 2B) and the identified non-essential portions 230 (FIG. 2B) of the received advertisement messages 212 (FIG. 2B) by classifying the identified essential and non-essential portions 220, 230 (FIG. 2B), and generating and presenting customized advertisement messages 212 (FIG. 2B) based on the classifications and the collected consumer profile data. Specifically, according to one embodiment, the advertisement customization program 108A, 108B (FIG. 1) may classify the identified essential and non-essential portions 220, 230 (FIG. 2B) by determining whether the identified essential and non-essential portions 220, 230 (FIG. 2B) include, for example, sports related material, humor, emotional material, and/or nostalgic material. Furthermore, the advertisement customization program 108A, 108B (FIG. 1) may collect consumer profile data by determining responses of each consumer/viewer to the classified and identified essential and non-essential portions 220, 230 (FIG. 2B) to identify the types of received advertisement message 212 (FIG. 2B) the consumer/viewer prefers as well as the days of the week, times of the day, times of the year, that the consumer/viewer may prefer the received advertisement messages 212 (FIG. 2B). Furthermore, the advertisement customization program 108A, 108B (FIG. 1) may enable advertisers to generate alternate/different advertisements based on the classifications and the collected consumer profile data.

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 800a, b and external components 900a, b illustrated in FIG. 4. Each of the sets of internal components 800a, b includes one or more processors 820, one or more computer-readable RAMs 822, and one or more computer-readable ROMs 824 on one or more buses 826, and one or more operating systems 828 and one or more computer-readable tangible storage devices 830. The one or more operating systems 828, the software program 114 (FIG. 1) and the advertisement customization program 108A (FIG. 1) in client computer 102 (FIG. 1), and the advertisement customization program 108B (FIG. 1) in network server computer 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as an advertisement customization program 108A and 108B (FIG. 1), can be stored on one or more of the respective portable computer-readable tangible storage devices 936, read via the respective R/W drive or interface 832, and loaded into the respective hard drive 830.

Each set of internal components 800a, b also includes network adapters or interfaces 836 such as a TCP/IP adapter cards, wireless Wi-Fi interface cards, or 3G or 4G wireless interface cards or other wired or wireless communication links. The advertisement customization program 108A (FIG. 1) and software program 114 (FIG. 1) in client computer 102 (FIG. 1), and the advertisement customization program 108B (FIG. 1) in network server 112 (FIG. 1) can be downloaded to client computer 102 (FIG. 1) from an external computer via a network (for example, the Internet, a local area network or other, wide area network) and respective network adapters or interfaces 836. From the network adapters or interfaces 836, the advertisement customization program 108A (FIG. 1) and software program 114 (FIG. 1) in client computer 102 (FIG. 1) and the advertisement customization program 108B (FIG. 1) in network server computer 112 (FIG. 1) are loaded into the respective hard drive 830. The network may comprise copper wires, optical fibers, wireless transmission, routers, firewalls, switches, gateway computers, and/or edge servers.

Each of the sets of external components 900a, b can include a computer display monitor 920, a keyboard 930, and a computer mouse 934. External components 900a, b can also include touch screens, virtual keyboards, touch pads, pointing devices, and other human interface devices. Each of the sets of internal components 800a, b also includes device drivers 840 to interface to computer display monitor 920, keyboard 930, and computer mouse 934. The device drivers 840, R/W drive or interface 832, and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

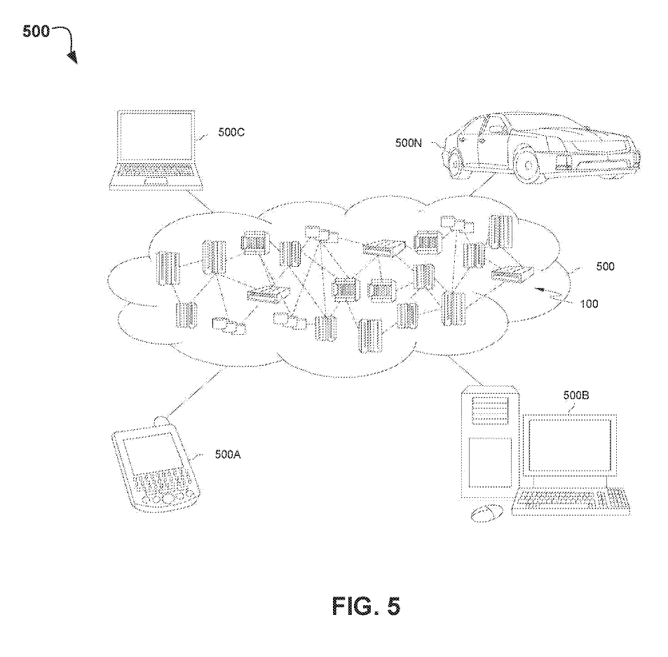

Referring now to FIG. 5, illustrative cloud computing environment 500 is depicted. As shown, cloud computing environment 500 comprises one or more cloud computing nodes 100 with which local computing devices used by cloud consumers, such as, for example, personal digital assistant (PDA) or cellular telephone 500A, desktop computer 500B, laptop computer 500C, and/or automobile computer system 500N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 500A-N shown in FIG. 5 are intended to be illustrative only and that computing nodes 100 and cloud computing environment 500 can communicate with any type of computerized device over any type of network and/or network addressable connection (e.g., using a web browser).

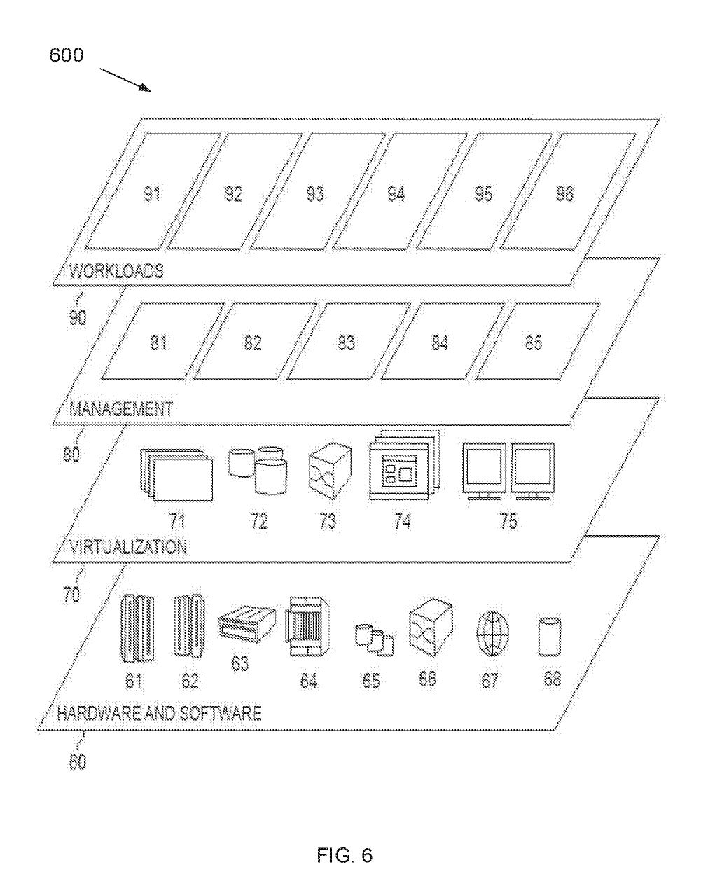

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and advertisement customization 96. An advertisement customization program 108A, 108B (FIG. 1) may be offered “as a service in the cloud” (i.e., Software as a Service (SaaS)) for applications running on mobile devices 102 (FIG. 1) and may generate and present customized advertisement messages to consumers.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating and presenting a plurality of customized advertisement messages to a plurality of consumers, the method comprising:
receiving a plurality of advertisement messages;
identifying at least one first essential portion and at least one first non-essential portion in each received advertisement message associated with the received plurality of advertisement messages by enabling at least one user to define the at least one first essential portion and the at least one first non-essential portion in each of the received advertisement messages, analyzing each of the received advertisement messages to determine the defined at least one first essential portion and the defined at least one first non-essential portion;
presenting the received plurality of advertisement messages to a plurality of consumers based on the identified at least one first essential portion and the identified at least one first non-essential portion;
collecting a plurality of consumer profile data on each consumer associated with the plurality of consumers based on the presented received plurality of advertisement messages;
based on the collected plurality of consumer profile data, identifying at least one second essential portion and at least one second non-essential portion in each of the presented received advertisement messages associated with the presented plurality of advertisement messages, wherein the identified at least one second essential portion and the identified at least one second non-essential portion modify the identified at least one first essential portion and the identified at least one first non-essential portion;
customizing the presented plurality of advertisement messages based on the identified at least one first essential portion, the identified at least one first non-essential portion, the identified at least one second essential portion, and the identified at least one second non-essential portion, to generate the plurality of customized advertisement messages for each consumer associated with the plurality of consumers; and
presenting the plurality of customized advertisement messages based on each consumer associated with the plurality of consumers.
